(19) United States
(12) Patent Application Publication
(10) Pub. No.: US 2009/0040463 A1
(43) Pub. Date: Feb. 12, 2009

(54) Illumination system of LED for projection display

(75) Inventors: Chun-Min Chen, Tainan County (TW); Kuan-Hsu Fan-Chiang, Tainan County (TW); Yen-Chen Chen, Tainan County (TW)

Correspondence Address: RABIN & Berdo, PC, 1101 14TH STREET, NW, SUITE 500, WASHINGTON, DC, 20005, US

(73) Assignee: Himax Display, Inc., Tainan County (TW)

(21) Appl. No.: 12/010,355

(22) Filed: Jan. 24, 2008

Related U.S. Application Data
(60) Provisional application No. 60/954,540, filed on Aug. 7, 2007.

(51) Int. Cl. F21V 21/28; F21V 14/00

(52) U.S. Cl. 353/20; 362/231; 353/98

(57) ABSTRACT

An illumination device and a projection system using the same are provided. The illumination device comprises a first light source module, a second light source module and a dichroic element. The first light source module comprises a first carrying board and a plurality of first light-emitting units disposed thereon for providing a first light beam. The second light source module comprises a second carrying board and a plurality of second and third light-emitting units disposed thereon for providing a second light beam. The dichroic element has a first side, a second side and a light output side. The first and the second light source modules are respectively optically aligned with the first side and the second side of the dichroic element, wherein the dichroic element provides a third light beam to the light output side by chromatically combining the first light beam and the second light beam.

This application claims the benefit of U.S. provisional application Ser. No. 60/954,540, filed Aug. 7, 2007, the subject matter of which is incorporated herein by reference.

### BACKGROUND OF THE INVENTION

1. Field of the Invention

The invention relates in general to an illumination device and a projection system using the same, and more particularly to a light-emitting diodes (LEDs) illumination device and a projection system using the same.

2. Description of the Related Art

The illumination device of the projection system can be categorized according to the type of the light source such as metal halide lamp and ultra-high pressure mercury lamp for example. However, both types of illumination device contain poisonous materials and are disadvantaged by larger volume, lower color saturation and shorter lifespan. Therefore, a new type of projection system whose light source is based on LEDs has gained a great popularity due to the features of not containing mercury, low power consumption, small volume, anti-pressure and anti-shock, wider color gamut, high color saturation, longer lifespan, not using inverter and faster start-up.

Generally speaking, the LED light source can be arranged as a 1-channel optical path or a 3-channel optical path and disposed in the projection system. Referring to FIG. 1 and FIG. 2. FIG. 1 is a disposition diagram of a 1-channel optical path LED. FIG. 2 is a disposition diagram of a 3-channel optical path LED. According to the 1-channel optical path as indicated in FIG. 1, the red LEDs 11, the green LEDs 12 and the blue LEDs 13 are disposed in the same direction so that after the LEDs 11, 12 and 13 respectively emit a light beam, the emitted light beams are directly mixed and projected into the optical engine 15, and then reflected from the light output side 15a of the optical engine 15. According to the 3-channel optical path as indicated in FIG. 2, the red LEDs 21, the green LEDs 22 and the blue LEDs 23 are disposed in different directions, so that the LEDs 21, 22 and 23 provide different light sources to the optical lens 25 (such as an X-cube) from three different directions, and then the light sources are reflected from the light output side 25a of the optical lens 25. In terms of the 1-channel optical path, the disadvantage is that the heat generated by the light source is hard to be dissipated and the luminance is not enough as different colored LEDs are packaged together. The disposition of the 3-channel optical path as indicated in FIG. 2 is capable of resolving the disadvantage of the 1-channel optical path but is disadvantaged by having a larger size and having difficulty in alignment during assembly.

As reduced size and high lumen are expected of the projection system, the user will find it hard for the LED light source to achieve excellent heat dissipation. As LEDs are sensitive to temperature, an illumination device and a projection system based on LEDs and possessing both the features of high lumen and satisfactory heat dissipation are in urgent need.

### SUMMARY OF THE INVENTION

The invention is directed to a light emitting diode (LED) illumination device and a projection system using the same. The illumination device of the invention has new disposition of LEDs, thereby reducing the size, increasing the lumens and improving heat dissipation.

According to a first aspect of the present invention, an illumination device comprising a first light source module, a second light source module and a dichroic element is provided. The first light source module comprises a first carrying board and a plurality of first light-emitting units disposed thereon for providing a first light beam. The second light source module comprises a second carrying board and a plurality of second and third light-emitting units disposed thereon for providing a second light beam. The dichroic element has a first side, a second side and a light output side. The first and the second light source modules are optically aligned with the first and the second sides of the dichroic element, wherein the dichroic element provides a third light beam to the light output side by chromatically combining the first light beam and the second light beam.

According to a second aspect of the present invention, a projection system comprising a reflective display panel and an illumination device is provided. The illumination device is for providing a light beam to the reflective display panel. The illumination device comprises a first light source module, a second light source module and a dichroic element. The first light source module comprises a first carrying board and a plurality of first light-emitting units disposed thereon for providing a first light beam. The second light source module comprises a second carrying board and a plurality of second and third light-emitting units disposed thereon for providing a second light beam. The dichroic element has a first side, a second side and a light output side. The first and the second light source modules are optically aligned with the first and the second sides of the dichroic element, wherein the dichroic element provides a third light beam to the light output side by chromatically combining the first light beam and the second light beam.

The invention will become apparent from the following detailed description of the preferred but non-limiting embodiments. The following description is made with reference to the accompanying drawings.

### BRIEF DESCRIPTION OF THE DRAWINGS

FIG. 1 (PriorArt) is a disposition diagram of a 1-channel optical path LED;

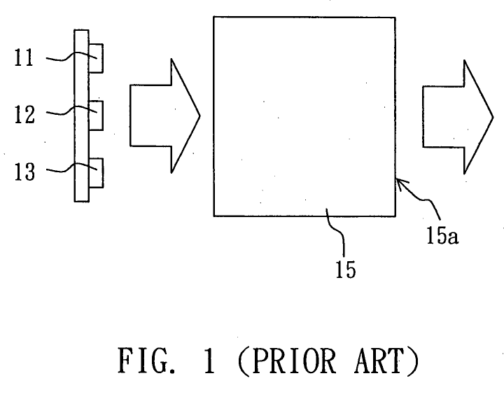

FIG. 2 (PriorArt) is a disposition diagram of a 3-channel optical path LED;

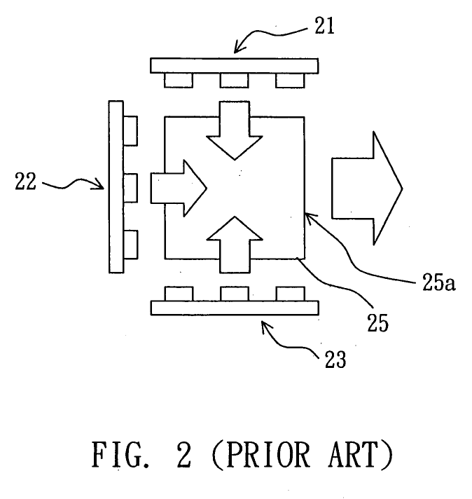

FIG. 3 is a perspective of an illumination device according to a preferred embodiment of the invention; and

FIG. 4 is a perspective of a projection system according to a preferred embodiment of the invention.

### DETAILED DESCRIPTION OF THE INVENTION

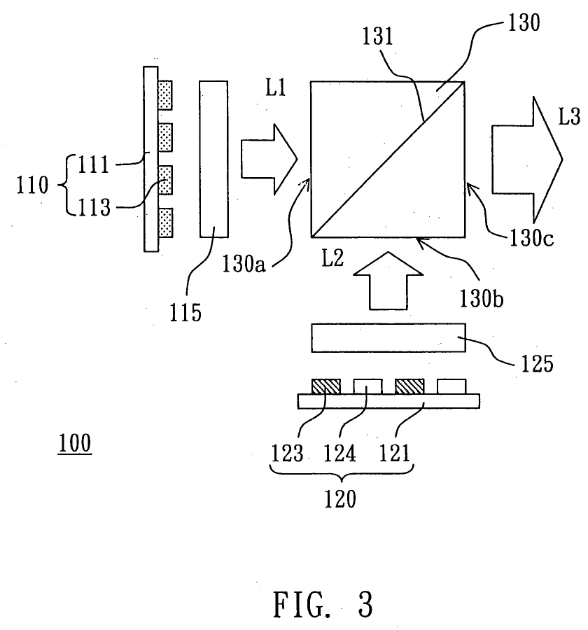

Referring to FIG. 3, a perspective of an illumination device according to a preferred embodiment of the invention is shown. As indicated in FIG. 3, the illumination device 100 comprises a first light source module 110, a second light source module 120 and a dichroic element 130.

The first light source module 110 comprises a first carrying board 111 and a plurality of first light-emitting units 113 disposed thereon for providing a first (non-polarized) light beam L1. The second light source module 120 comprises a second carrying board 121 and a plurality of second light-emitting units 123 and third light-emitting units 124 disposed thereon for providing a second (non-polarized) light beam L2. Moreover, the first light source module 110 and the second light source module 120 respectively comprise a light-concentrating element 115 and a light-concentrating element 125 which are respectively disposed adjacent to the light-emitting units 113 of the first light source module 110 and the light-emitting units 123 and 124 of the second light source module 120 for converging the first light beam L1 and the second light beam L2 and transforming the first light beam L1 and the second light beam L2 into substantially uniform light beams. Besides, the light-concentrating elements 115 and 125 applicable to the invention are preferably but not limited to a compound parabolic concentrator (CPC). However, the light-concentrating elements 115 and 125 also can be other concentrator consisted of several light-concentrating components.

The dichroic element 130 has a first side 130a, a second side 130b and a light output side 130c. The first light source module 110 and the second light source module 120 are optically aligned with the first side 130a and the second side 130b of the dichroic element 130, wherein the dichroic element 130 provides a third (non-polarized) light beam L3 to the light output side 130c by chromatically combining the first light beam L1 and the second light beam L2.

In the present embodiment of the invention, the first light-emitting units 113 are green LEDs, the second light-emitting units 123 are red LEDs, and the third light-emitting units 124 are blue LEDs. Therefore, if the first light beam L1 is a green light beam, then the second light beam L2 is a magenta light beam mixed by the red light beam and the blue light beam, and the third light beam L3 mixed by the first light beam L1 and the second light beam L2 is substantially a white light beam. Preferably, the ratio of the green, the red to the blue LEDs is 2:1:1 for generating the above white light beam.

Besides, the dichroic element 130 applicable to the invention comprises a dichroic mirror 131 for allowing the first light beam L1 to pass through and reflecting the second light beam L2 so that the first light beam L1 and the second light beam L2 are propagated in the same direction, that is, the direction of the third light beam L3 as indicated in FIG. 3. According to the disposition of the 2-channel optical path LEDs of FIG. 3, the first light-emitting units 113 exemplified by green LEDs are disposed in an optical path alone for providing a green light beam, and the second light-emitting units 123 and the third light-emitting units 124 which are exemplified by red and blue LEDs respectively are disposed in another optical path for providing a magenta light beam. According to the disposition of the first light source module 110 and the second light source module 120, the dichroic mirror 131 can use a green/magenta dichroic mirror.

The illumination device 100 disclosed in the above embodiment of the invention, having reduced size, still can possess the quality of high lumen and satisfactory heat dissipation. Firstly, according to a conventional method of generating a substantially white light beam, the green, the red and the blue lights are mixed according to a specific ratio. As the green light dominates the ratio, the red light and the blue light are normally lessened in order to generate a substantially white light beam. In comparison, according to the disposition of the 2-channel optical path of the present embodiment of the invention, the green LEDs are disposed in an optical path, the red LEDs and the blue LEDs are disposed in another optical path, and the mixing ratio is controlled to be 2:1:1 for generating a substantially white light beam. Therefore, the lumen of the 2-channel-optical path LEDs of the present embodiment of the invention is comparable to the lumen of the disposition of the conventional 3-channel optical path. Moreover, in terms of the reduction in size, the disposition of the 2-channel optical path LEDs of the present embodiment of the invention is superior to the disposition of the conventional 3-channel optical path. Secondly, when the size is reduced and that the LEDs producing the same lumen is desired, the heat dissipation in a disposition of decentralized LEDs is superior to that in a disposition of centralized LEDs. Therefore, the heat dissipation in the 2-channel optical path LEDs of the present embodiment of the invention is superior to the heat dissipation in the conventional 1-channel optical path. Compared with the disposition of 3-channel optical path, the disposition of 2-channel optical path saves more space and is easier to be aligned during assembly.

According to the preferred embodiment of the invention, the illumination device 100 is applicable to a projection system for providing a light beam to a display element. The display element can be installed in 1-LCD projection system, 3-LCD projection system, LCOS projection system or DMD projection system. It is preferred but not limited that the display element of the present embodiment of the invention is a reflective display panel. However, any one who is skilled in the technology of the invention will understand that the invention is also applicable to other display elements.

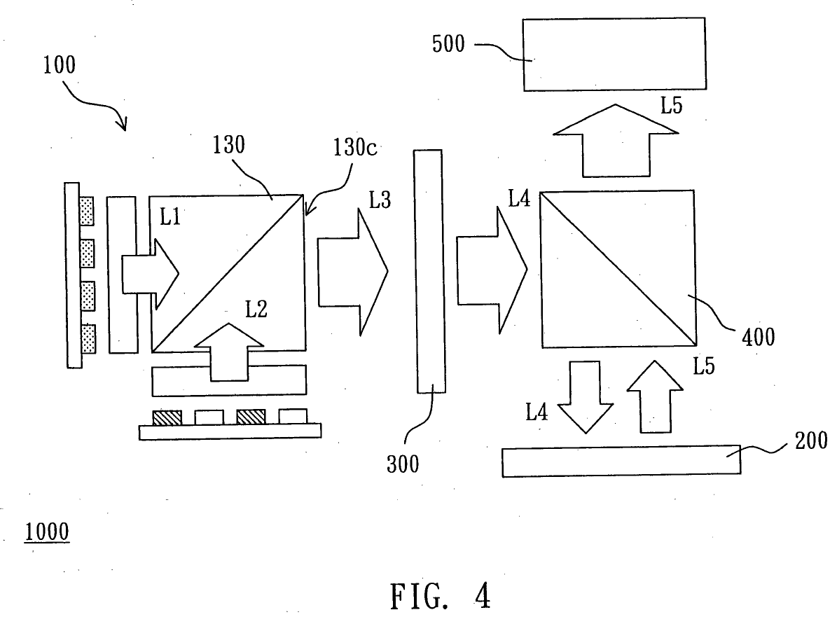

Referring to FIG. 4, a perspective of a projection system according to a preferred embodiment of the invention is shown. As indicated in FIG. 4, the projection system 1000 comprises an illumination device 100, a reflective display panel 200, a pre polarizer 300, a light-beam division element 400 and a projection lens 500. The illumination device 100 and the light beams L1, L2 and L3 are already elaborated in FIG. 3 and are not repeated here.

As indicated in FIG. 4, the pre polarizer 300 corresponds to the light output side 130c of the dichroic element 130 for transforming the third non-polarized light beam L3 into a first polarized light beam L4.

In FIG. 4, the light-beam division element 400 corresponds to one side of the pre polarizer 300 for receiving the first polarized light beam L4 and projecting the received first polarized light beam L4 to the reflective display panel 200. Meanwhile, the reflective display panel 200, according to an image, transforms the first polarized light beam L4 into a second polarized light beam L5 and reflects the second polarized light beam L5 to the light-beam division element 400. Besides, the light-beam division element 400 applicable to the invention is a polarization beam splitter (PBS) for reflecting the first polarized light beam L4 to the reflective display panel 200. Alternatively, the polarization beam splitter allows the first polarized light beam L4 to pass through and reach the reflective display panel 200.

In FIG. 4, the projection lens 500 is disposed adjacent to the light-beam division element 400 for projecting the second polarized light beam L5 to form an image.

According to the illumination device and the projection system using the same disclosed in the above embodiments of the invention, different colored light-emitting units of the illumination device are arranged as a 2-channel optical path, not only achieving satisfactory heat dissipation and high lumen but also saving space and reducing the size.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An illumination device, comprising:
a first light source module having a first carrying board and a plurality of first color light-emitting units disposed on the first carrying board for providing a first (non-polarized) light beam;
a second light source module having a second carrying board, a plurality of second color light-emitting units and a plurality of third color light-emitting units disposed on the second carrying board for providing a second (non-polarized) light beam; and
a dichroic element having a first side, a second side and a light output side, wherein the first light source module and the second light source module are respectively optically aligned with the first side and the second side of the dichroic element, and wherein said dichroic element adapts to provide a third (non-polarized) light beam to the light output side by chromatically combining the first (non-polarized) light beam and the second (non-polarized) light beam.

2. The illumination device according to claim 1, wherein the first color light-emitting units are green LEDs, the second color light-emitting units are red LEDs, and the third color light-emitting units are blue LEDs.

3. The illumination device according to claim 1, wherein the third light beam is substantially a white light beam.

4. The illumination device according to claim 1, wherein each of the first and the second light source modules further comprises:
a light-concentrating element disposed adjacent to the light source module for converging light provided by the light source module and providing substantially uniform light of each light beam.

5. The illumination device according to claim 4, wherein the light-concentrating element is a compound parabolic concentrator.

6. The illumination device according to claim 1, wherein the dichroic element further comprises a dichroic mirror, which allows the first light beam to pass through and reflect the second light beam so as to be propagated in the same direction.

7. The illumination device according to claim 6, wherein the dichroic mirror is a green/magenta dichroic mirror.

8. A projection system, comprising:
a reflective display panel; and
an illumination device for providing a light beam to the reflective display panel, the illumination device further comprising:
a first light source module having a first carrying board and a plurality of first color light-emitting units disposed on the first carrying board for providing a first (non-polarized) light beam;
a second light source module having a second carrying board, a plurality of second color light-emitting units and a plurality of third color light-emitting units both disposed on the second carrying board for providing a second (non-polarized) light beam; and
a dichroic element having a first side, a second side and a light output side, wherein the first light source module and the second light source module are respectively optically aligned with the first side and the second side of the dichroic element, and wherein said dichroic element adapts to provide a third (non-polarized) light beam to the light output side by chromatically combining the first (non-polarized) light beam and the second (non-polarized) light beam.

9. The projection system according to claim 8, wherein the first color light-emitting units are green LEDs, the second color light-emitting units are red LEDs, and the third color light-emitting units are blue LEDs.

10. The projection system according to claim 8, wherein the third light beam is substantially a white light beam.

11. The projection system according to claim 8, wherein each of the first and the second light source modules further comprises:
a light-concentrating element disposed adjacent to the light source module for converging light provided by the light source module and providing substantially uniform light of each light beam.

12. The projection system according to claim 11, wherein the light-concentrating element is a compound parabolic concentrator.

13. The projection system according to claim 8, wherein the dichroic element further comprises a dichroic mirror, which allows the first light beam to pass through and reflect the second light beam so as to be propagated in the same direction.

14. The projection system according to claim 13, wherein the dichroic mirror is a green/magenta dichroic mirror.

15. The projection system according to claim 8, further comprising:
a pre-polarizer disposed in the light output side of the dichroic element for transforming the third non-polarized light beam into a first polarized light beam.

16. The projection system according to claim 15, further comprising:
a light-beam division element disposed at one side of the pre-polarizer, for receiving the first polarized light beam and projecting the received light beam onto the reflective display panel.

17. The projection system according to claim 16, wherein the reflective display panel transforms the first polarized light beam into a second polarized light beam according to an image and reflects the second polarized light beam to the light-beam division element.

18. The projection system according to claim 17, wherein the light-beam division element is a polarization beam splitter (PBS), which reflects the first polarized light beam to the reflective display panel.

19. The projection system according to claim 17, wherein the light-beam division element is a polarization beam splitter, which allows the first polarized light beam to pass through and reach the reflective display panel.

20. The projection system according to claim 17, further comprising:
a projection lens, disposed adjacent to the light-beam division element for projecting the second polarized light beam to form the image.
